(19) United States
(12) Patent Application Publication
(10) Pub. No.: US 2020/0076962 A1
(43) Pub. Date: Mar. 5, 2020

(54) IMAGE FORMING SYSTEM AND PROGRAM

(71) Applicant: KONICA MINOLTA, INC., Tokyo (JP)

(72) Inventor: Hiroyuki KONISHI, Tokyo (JP)

(73) Assignee: KONICA MINOLTA, INC., Tokyo (JP)

(21) Appl. No.: 16/521,635

(22) Filed: Jul. 25, 2019

(30) Foreign Application Priority Data
Aug. 29, 2018 (JP) 2018-160455

(51) Int. Cl. H04N 1/00

(52) U.S. Cl. CPC H04N 1/0092; H04N 1/00477; H04N 1/00631

(57) ABSTRACT

An image forming system includes: a job information acquirer that acquires job information made up of a plurality of jobs, the job information indicating contents of a process to be performed on a sheet; an image former that forms an image on a sheet based on the job information; and a hardware processor that designates an execution order of the plurality of jobs in the image former, based on a next phase to be performed when the sheets are conveyed from the image former after an image forming phase by the image former for each of the plurality of jobs in the job information.

The entire disclosure of Japanese patent Application No. 2018-160455, filed on Aug. 29, 2018, is incorporated herein by reference in its entirety.

### BACKGROUND

### Technological Field

The present invention relates to an image forming system and a program that form an image on a sheet.

### Description of the Related Art

An image forming system includes an image forming apparatus that forms an image on a sheet, and a stacking apparatus that stacks the sheet on which the image has been formed by the image forming apparatus. Then, in the image forming apparatus, an image processing apparatus forms an image on a sheet based on output job information. Furthermore, there is a case where, in the image forming system, a post-process is performed on the sheets stacked in the stacking apparatus by a post-processing apparatus as a post-phase.

In addition, as an image forming system, for example, there is a system as described in JP 2014-98875 A. JP 2014-98875 A discloses a technique in which, when sheets stacked on a large-capacity stacker are manually conveyed to a post-processing apparatus and a post-process is carried out on the conveyed sheets, a central processing unit (CPU) of an image forming apparatus sets an upper limit number of sheets to be stacked, based on the maximum number of sheets to be stacked on the large-capacity stacker and the maximum number of sheets to be post-processed by the post-processing apparatus.

Note that, in the image forming system, there is a case where a plurality of jobs is performed and sheets of the plurality of jobs are stacked on the stacking apparatus, in which case the sheets are stacked in the stacking apparatus sequentially in the execution order in the image forming apparatus. Therefore, the sheet of a job executed earlier by the image forming apparatus is stacked below the sheet of a job executed later. In addition, when sheets are set in the post-processing apparatus, it is necessary to set the sheets based on the execution order in which the post-processing apparatus performs a post-process. Therefore, when the sheet of a job to be executed earlier in the post-processing apparatus is stacked below the sheet of a job to be executed later, it has been necessary to temporarily put aside the sheet of the later job in the execution order, in another place. As a result, the work of setting the sheets in the post-processing apparatus becomes complicated, which causes a burden on a user.

### SUMMARY

In view of the conventional problems as described above, the present invention aims to provide an image forming system and a program capable of reducing a burden on a user caused by a work of setting a sheet on which an image is formed, for the next phase.

To achieve the abovementioned object, according to an aspect of the present invention, an image forming system reflecting one aspect of the present invention comprises: a job information acquirer that acquires job information made up of a plurality of jobs, the job information indicating contents of a process to be performed on a sheet; an image former that forms an image on a sheet based on the job information; and a hardware processor that designates an execution order of the plurality of jobs in the image former, based on a next phase to be performed when the sheets are conveyed from the image former after an image forming phase by the image former for each of the plurality of jobs in the job information.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a schematic configuration diagram illustrating an overall configuration of an image forming system according to a first embodiment of the present invention;

FIG. 2 is a block diagram illustrating a hardware configuration of the image forming system according to the first embodiment of the present invention;

FIG. 3 is an explanatory diagram illustrating an example of job information in the image forming system according to the first embodiment of the present invention;

FIG. 4 is an explanatory diagram illustrating an action example of a conventional image forming system;

FIG. 5 is an explanatory diagram illustrating an action example of the image forming system according to the first embodiment of the present invention;

FIG. 6 is a flowchart illustrating a scheduling process and a job execution process in the image forming system according to the first embodiment of the present invention;

FIG. 7 is an explanatory diagram illustrating the job information in the image forming system according to the first embodiment of the present invention;

FIG. 8 is a flowchart illustrating an execution order designation process in the image forming system according to the first embodiment of the present invention;

FIG. 9 is an explanatory diagram illustrating a reservation list designated in the execution order designation process;

FIG. 10 is a flowchart illustrating a last job search process in the image forming system according to the first embodiment of the present invention;

FIG. 11 is a flowchart illustrating an execution order designation process in an image forming system according to a second embodiment of the present invention;

FIG. 12 is an explanatory diagram illustrating job information in the image forming system according to the second embodiment of the present invention; and

FIG. 13 is an explanatory diagram illustrating a reservation list designated in the execution order designation process.

### DETAILED DESCRIPTION OF EMBODIMENTS

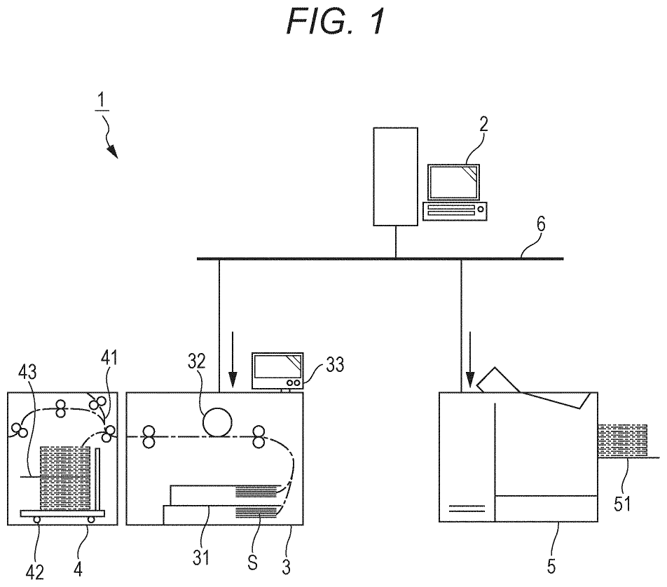

Hereinafter, one or more embodiments of an image forming system and a program of the present invention will be described with reference to FIGS. 1 to 13. Note that, in the respective drawings, common members are denoted by the same reference numerals. In addition, the scope of the invention is not limited to the disclosed embodiments.

### 1. First Embodiment

1-1. Configuration of Image Forming System

Initially, an overall configuration of an image forming system according to a first embodiment of the present invention (hereinafter referred to as “the present example”) will be described. FIG. 1 is a schematic configuration diagram of the image forming system 1 of the present example.

As illustrated in FIG. 1, the image forming system 1 includes an information processing apparatus 2 constituting an image forming server, an image forming apparatus 3, a large-capacity stacker 4 representing a sheet stacking apparatus, and a case binding machine 5 representing an example of a post-processing apparatus. The information processing apparatus 2, the image forming apparatus 3, the large-capacity stacker 4, and the case binding machine 5 are each connected to a network 6 such as a local area network (LAN) and are mutually connected via the network 6.

A personal computer is applied as the information processing apparatus 2. The information processing apparatus 2 generates image data for forming an image by a document creation or image forming application based on an input operation of a user. In addition, the information processing apparatus 2 outputs the image data and job information indicating the contents of a process to be performed on a sheet S to the image forming apparatus 3 and the case binding machine 5 via the network 6. Note that the job information is converted into a job definition format (JDF) and then output to the image forming apparatus 3 and the case binding machine 5.

The image forming apparatus 3 receives the job information and the image data output from the information processing apparatus 2 via the network 6, and forms an image on the sheet S based on an image formation setting in the job information and the image data. The image forming apparatus 3 is an apparatus that forms an image on the sheet S by, for example, an electrophotographic method. The image forming apparatus 3 includes a sheet feeder 31 in which the sheet S on which an image is to be formed is accommodated, an image former 32 that forms an image on the sheet S, and an operation display part 33.

The image former 32 includes, for example, image forming units of a plurality of colors (cyan, magenta, yellow, black, and the like) and can form a color toner image on a sheet. On a downstream side of the image former 32 in a sheet conveyance direction (simply referred to as “downstream side”), a fixer (not illustrated) to which the sheet on which the toner image is formed is conveyed is disposed. The toner image transferred by pressing and heating the sheet is fixed to the sheet by the above-mentioned fixer.

The large-capacity stacker 4 is disposed on a downstream side of the image forming apparatus 3 in the conveyance direction of the sheet S. That is, the image forming apparatus 3 and the large-capacity stacker 4 are arranged in series. The sheet S on which the image has been formed by the image forming apparatus 3 is conveyed to the large-capacity stacker 4.

The large-capacity stacker 4 has a sheet conveyer 41, a stacker part 43 representing an example of a stacking part on which the sheets S are stacked, and a carriage 42 on which the stacker part 43 is disposed. The sheet conveyer 41 conveys the sheet S conveyed from the image forming apparatus 3 toward the stacker part 43. The stacker part 43 is configured so as to be removable from a housing of the large-capacity stacker 4 together with the carriage 42.

The case binding machine 5 is disposed at a position physically separated from the image forming apparatus 3 and the large-capacity stacker 4. The sheets S stacked on the stacker part 43 are conveyed to the case binding machine 5 by the carriage 42.

The case binding machine 5 performs a post-process on the sheets S stacked on a sheet feeding tray of a sheet feeder 51. The case binding machine 5 performs so-called case binding in which a plurality of the sheets S is bundled and wrapped with a cover and thus a booklet is created.

Note that the present example has described an example in which the case binding machine 5 is applied as the post-processing apparatus, but the present invention is not limited to this example. For example, a foil-stamping machine that performs foil stamping on the sheet S, a cutting machine that cuts the sheet S, a staple processing machine that performs a staple process on the sheet S, and other various post-processing apparatuses are applied as the post-processing apparatus.

1-2. Hardware Configuration of Each Apparatus

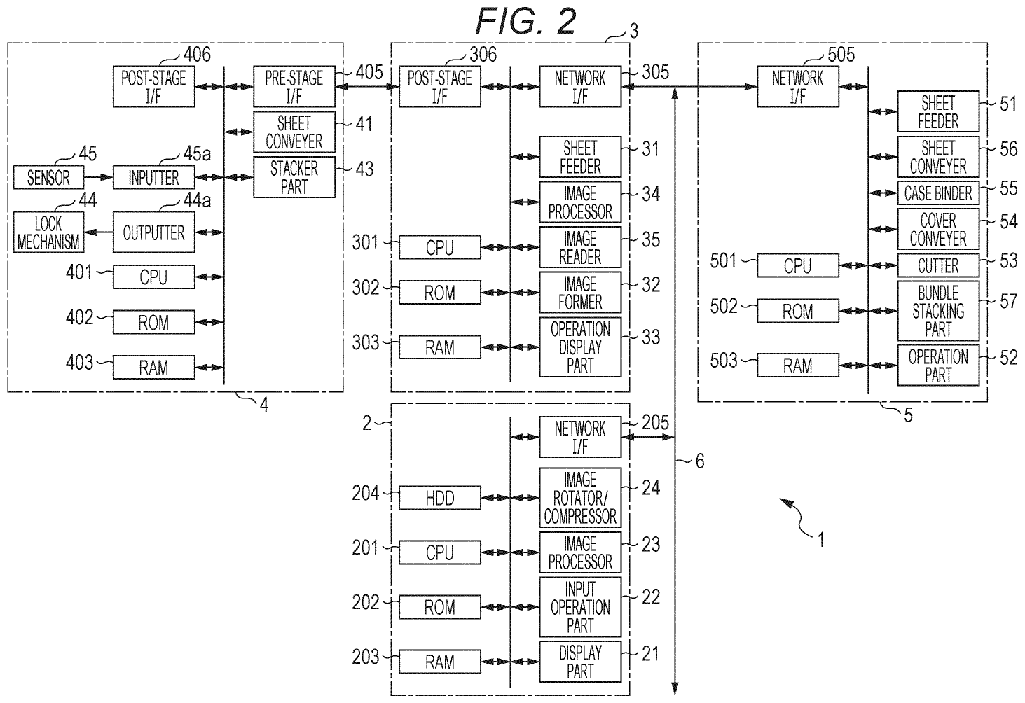

Next, the hardware configuration of each apparatus will be described with reference to FIG. 2.

FIG. 2 is a block diagram illustrating the hardware configuration of each apparatus of the image forming system.

Initially, the hardware configuration of the information processing apparatus 2 will be described.

As illustrated in FIG. 2, the information processing apparatus 2 includes a display part 21, an input operation part 22, an image processor 23, and an image rotator/compressor 24. The information processing apparatus 2 also has a central processing unit (CPU) 201, a read only memory (ROM) 202 for storing a program and the like executed by the CPU 201, and a random access memory (RAM) 203 used as a work area of the CPU 201. The information processing apparatus 2 further includes a hard disk drive (HDD) 204 as a mass storage device, and a network interface (I/F) 205. Note that an electrically erasable programmable ROM is usually used as the ROM 202. In addition, the CPU 201 representing an example of a controller controls the entire information processing apparatus 2.

Furthermore, the display part 21, the input operation part 22, the image processor 23, the image rotator/compressor 24, the CPU 201, the ROM 202, the RAM 203, the HDD 204, and the network I/F 205 are all connected via a system bus so as to be able to mutually communicate.

The display part 21 is, for example, a display monitor such as a liquid crystal display (LCD) or an organic electro luminescence display (ELD), and displays a result or the like of a process performed by the information processing apparatus 2. For example, a keyboard, a mouse, a touch panel, or the like is used for the input operation part 22. Then, the input operation part 22 allows the user to make a predetermined operation input and instruction. In addition, an operation display panel may be configured by integrally laminating a touch panel applied as the input operation part 22 and a flat panel display applied as the display part 21.

The image processor 23 implements processes such as shading correction and a dither process on image data created by analog-to-digital (A/D) conversion, and retains the processed image data in the RAM 203. The image rotator/compressor 24 performs a rotation process, a compression process, and the like on the image data and retains the processed image data in the RAM 203.

For example, a network interface card (NIC) or the like is used for the network I/F 205, and the network I/F 205 is configured such that the respective apparatuses can transmit and receive various types of data to and from each other via the network 6.

Next, the hardware configuration of the image forming apparatus 3 will be described. The image forming apparatus 3 includes the sheet feeder 31, the image former 32, the operation display part 33, an image processor 34, and an image reader 35. The image forming apparatus 3 also has a CPU 301, a ROM 302 for storing a program and the like executed by the CPU 301, and a RAM 303 used as a work area of the CPU 301. The image forming apparatus 3 further has a network I/F 305 representing an example of a job information acquirer, and a post-stage I/F 306. The CPU 301 representing an example of the controller controls the entire image forming apparatus 3.

Furthermore, the sheet feeder 31, the image former 32, the operation display part 33, the image processor 34, the image reader 35, the CPU 301, the ROM 302, the RAM 303, the network I/F 305, and the post-stage I/F 306 are all connected via a system bus so as to be able to mutually communicate.

The image reader 35 optically reads an original image and converts the read original image into an electrical signal. For example, in the case of reading a color original, image data having luminance information of 10 bits per pixel each for RGB is generated. Image data generated by the image reader 35 and image data transmitted from the information processing apparatus 2 are sent to the image processor 34 and subjected to an image process. The image processor 34 performs image processes such as shading correction, image density adjustment, and image compression on the received image data as necessary. In addition, the image former 32 accepts the image data subjected to the image process by the image processor 34 and forms an image on the sheet S based on the image data.

The operation display part 33 is a touch panel constituted by a display such as a liquid crystal display (LCD) apparatus or an organic electro luminescence display (ELD). This operation display part 33 is an example of an outputter and displays an instruction menu for the user, information regarding the acquired image data, and the like. Furthermore, the operation display part 33 includes a plurality of keys and accepts inputs of various instructions and data such as characters and numbers by user's key operation to output input signals to the CPU 301.

For example, an NIC or the like is used for the network I/F 305, and the network I/F 305 is configured such that the respective apparatuses can transmit and receive various types of data to and from each other via the network 6. For example, an NIC or the like is also used for the post-stage I/F 306 to establish a connection with the large-capacity stacker 4 connected at the post-stage of the image forming apparatus 3, and the post-stage I/F 306 executes data transmission and reception.

Next, the hardware configuration of the large-capacity stacker 4 will be described. The large-capacity stacker 4 includes the sheet conveyer 41, the stacker part 43, a lock mechanism 44, and a sensor 45. The large-capacity stacker 4 also has a CPU 401 that controls the entire large-capacity stacker 4, a ROM 402 for storing a program and the like executed by the CPU 401, and a RAM 403 used as a work area of the CPU 401. The large-capacity stacker 4 further has a pre-stage I/F 405 and a post-stage I/F 406.

The sheet conveyer 41, the stacker part 43, the lock mechanism 44, the sensor 45, the CPU 401, the ROM 402, the RAM 403, the pre-stage I/F 405, and the post-stage I/F 406 are all connected via a system bus so as to be able to mutually communicate.

The lock mechanism 44 locks the carriage 42 (see FIG. 1) in which the stacker part 43 is disposed, to the housing of the large-capacity stacker 4. In addition, the lock mechanism 44 is connected to the system bus via an outputter 44a. Then, the lock mechanism 44 is locked and unlocked based on an output signal output from the CPU 401 via the outputter 44a. By unlocking the lock mechanism 44, the stacker part 43 can be removed from the housing together with the carriage 42.

The sensor 45 is disposed in the sheet conveyer 41 or the stacker part 43. The sensor 45 detects the sheet S conveyed by the sheet conveyer 41 and the sheet S stacked on the stacker part 43. In addition, the sensor 45 is connected to the system bus via an inputter 45a. A detection signal detected by the sensor 45 is input to the CPU 401 via the inputter 45a.

For example, an NIC or the like is also used for the pre-stage I/F 405 to establish a connection with the image forming apparatus 3 connected to the pre-stage of the large-capacity stacker 4, and the pre-stage I/F 405 executes data transmission and reception. For example, when an NIC or the like is used and a certain apparatus is connected to the post-stage of the large-capacity stacker 4, the post-stage I/F 406 establishes a connection with the certain apparatus and executes data transmission and reception.

Next, the hardware configuration of the case binding machine 5 will be described. The case binding machine 5 includes the sheet feeder 51, an operation part 52, a cutter 53, a cover conveyer 54, a case binder 55, a sheet conveyer 56, and a bundle stacking part 57. The case binding machine 5 also has a CPU 501 that controls the entire case binding machine 5, a ROM 502 for storing a program and the like executed by the CPU 501, and a RAM 503 used as a work area of the CPU 501. The case binding machine 5 further has a network I/F 505.

The sheet feeder 51 has a sheet feeding tray, and the sheet S conveyed from another apparatus (in the present example, the large-capacity stacker 4) is placed on the sheet feeding tray. Then, the sheet feeder 51 feeds the sheet S placed on the sheet feeding tray to the sheet conveyer 56. The sheet conveyer 56 conveys the sheet S fed from the sheet feeder 51 to each part of the case binding machine 5 and finally conveys the sheet S to the bundle stacking part 57.

The operation part 52 is, for example, a touch panel that allows an input operation to be performed in accordance with information displayed on a display panel, which is a display part. The operation part 52 accepts inputs of various instructions and data such as characters and numbers by user's key operation, and outputs input signals to the CPU 501.

The cutter 53 is, for example, a roller cutter unit constituted by a rotary blade and a fixed blade and cuts the cover sheet and the sheet S into a predetermined length. The case binder 55 bundles a plurality of the sheets S to perform a binding process on the bundled sheets and attaches a cover to the bundled sheets. With this procedure, the case binder 55 performs a case binding process on the sheets S to create a booklet. The cover conveyer 54 conveys a cover used when a booklet is created, to the case binder 55. The bundle stacking part 57 stacks the booklet created by the case binder 55 on a stacker.

Note that the information processing apparatus 2, the image forming apparatus 3, the large-capacity stacker 4, and the case binding machine 5 may include processing units such as a micro processing unit (MPU) instead of the CPUs 201, 301, 401, and 501.

1-3. Example of Job Information

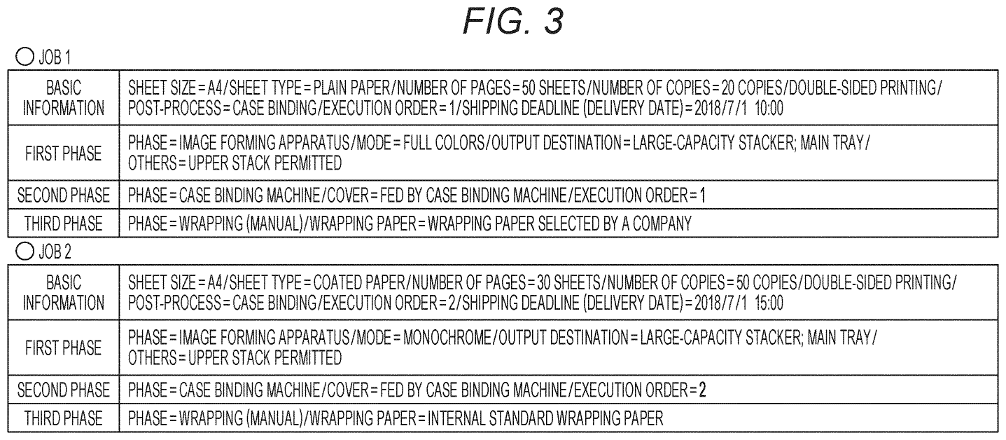

Next, an example of the job information output from the information processing apparatus 2 will be described with reference to FIG. 3.

FIG. 3 is an explanatory diagram illustrating an example of the job information.

For example, information as illustrated in FIG. 3 is described in the job information output from the information processing apparatus 2, that is, the JDF. As illustrated in FIG. 3, for example, the contents of work phases are described in the JDF for each job. For example, the sheet size, the sheet type, the number of pages, the number of copies, double-sided printing or single-sided printing, the post-process, the execution order, and the shipping deadline are described as basic information. In addition, in a first phase, information such as the contents of the phase, the mode, the output destination, and information as to whether or not the upper stack is permitted as additional information is described. In a second phase, information such as the contents of the phase, the cover, and the execution order is described. Then, in a third phase, information such as the contents of the phase and the type of wrapping paper is described.

1-4. Action Example

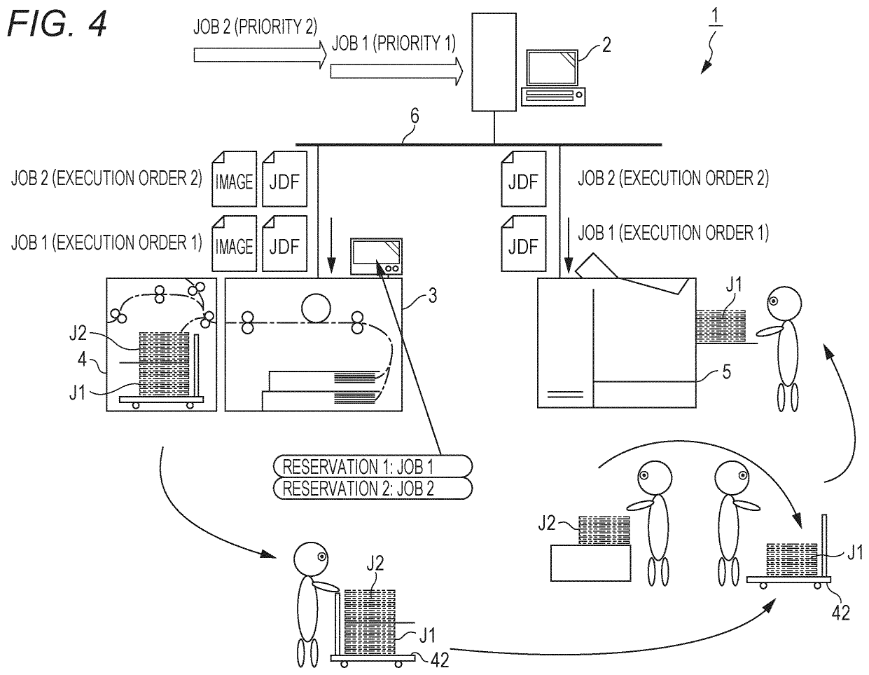

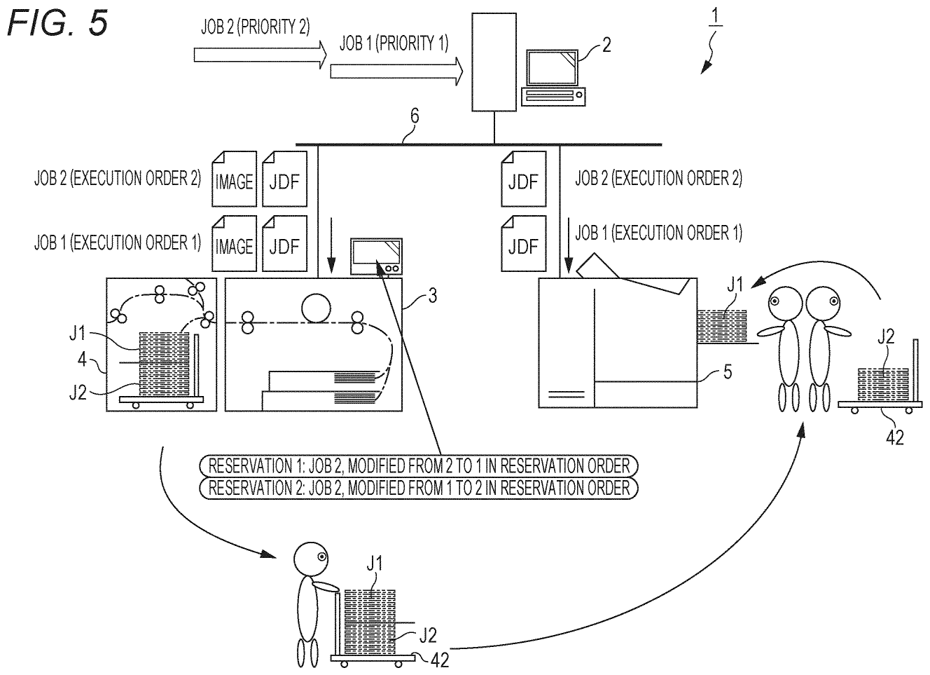

Next, an action example of the image forming system 1 having the above-described configuration will be described with reference to FIGS. 4 and 5.

FIG. 4 is an explanatory diagram illustrating a conventional action example, while FIG. 5 is an explanatory diagram illustrating an action example of the present example. Note that the action examples in FIGS. 4 and 5 will describe action examples based on the job information illustrated in FIG. 3.

As illustrated in FIG. 4, in the conventional action example, once the job information (JDF) is input from the information processing apparatus 2, the image forming apparatus 3 forms an image on the sheet S based on the input job information. As illustrated in FIG. 3, job 1 is set as the first in the execution order and job 2 is set as the second in the execution order. Therefore, the information processing apparatus 2 initially executes job 1 assigned as the first in the execution order, and then executes job 2 assigned as the second in the execution order. As a result, in the stacker part 43 of the large-capacity stacker 4, a sheet bundle J1 of job 1 is initially stacked, and a sheet bundle J2 of job 2 is stacked on top of the sheet bundle J1 of job 1.

Next, the user conveys the carriage 42 on which the sheet bundle J1 of job 1 and the sheet bundle J2 of job 2 are stacked, from the large-capacity stacker 4 to the case binding machine 5, which is a post-processing apparatus. Note that, in the job information illustrated in FIG. 3, the execution order in the case binding machine 5, which is included in the second phase, is set such that job 1 is assigned as the first and job 2 is assigned as the second. Therefore, when setting the sheet bundles J1 and J2 in the case binding machine 5, the user has needed to once place the sheet bundle J2 of job 2 stacked on the upper side on the carriage 42 in another place and then set the sheet bundle J1 of job 1 assigned as the first in the execution order, in the case binding machine 5.

In contrast to this procedure, in the image forming system 1 of the present example, as illustrated in FIG. 5, once the job information (JDF) is input from the information processing apparatus 2, the image forming apparatus 3 reads the execution order in the second phase, which is the next phase, from the input job information. Then, the image forming apparatus 3 modifies the execution order in which the image forming apparatus 3 performs jobs, based on the execution order in the second phase.

When the job information illustrated in FIG. 3 is input, the image forming apparatus 3 modifies job 2 assigned as the second in the execution order in the second phase to the first in the reservation order of the execution order of the image forming apparatus 3. Then, job 1 representing the first job assigned as the first in the execution order in the second phase is modified to the second in the reservation order of the execution order of the image forming apparatus 3. Thereafter, the image forming apparatus 3 performs an image forming process in accordance with the modified reservation order. Therefore, in the image forming apparatus 3, job 2 representing the second job is executed first, and job 1 is executed second. As a result, the sheet bundle J2 of job 2 is stacked on the stacker part 43 of the large-capacity stacker 4, and the sheet bundle J1 of job 1 is stacked on top of the sheet bundle J2 of job 2.

Next, the user conveys the carriage 42 on which the sheet bundle J1 of job 1 and the sheet bundle J2 of job 2 are stacked, to the case binding machine 5. As described above, since the sheet bundle J1 of job 1 is stacked on top of the sheet bundle J2 of job 2, the user can set the sheet bundle J1 of job 1 in the case binding machine 5 without once placing the sheet bundle J2 of job 2 in another place. As a result, the work to set sheets in the case binding machine 5, which is a post-processing apparatus, is more easily performed and the burden on the user is reliably reduced.

1-5. Action Example of Scheduling Process and Execution Process

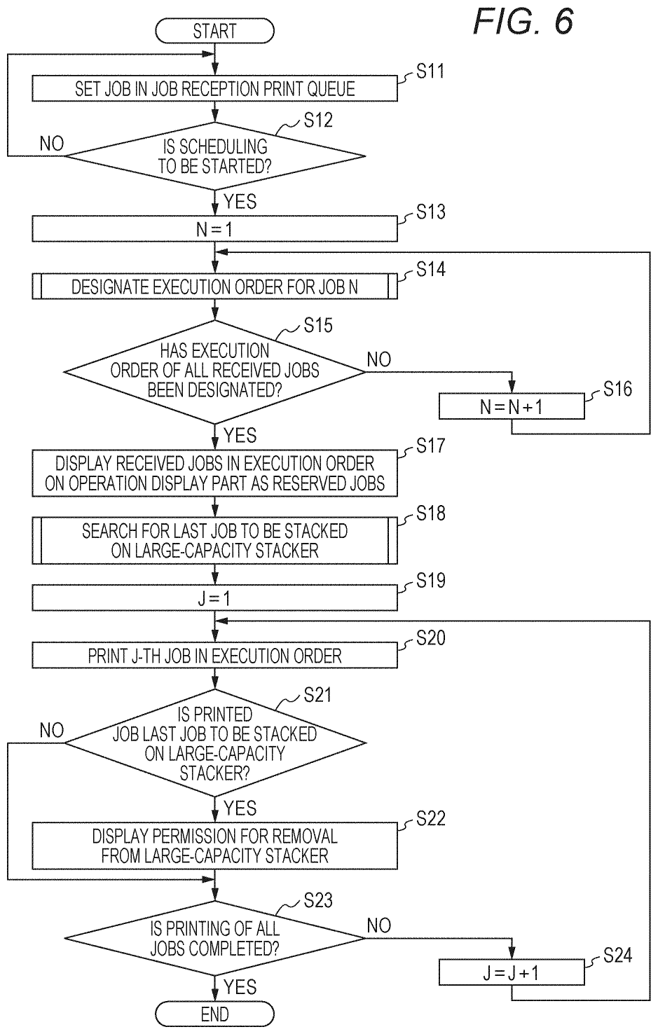

Next, an action example of a scheduling process and a job execution process that adjust the job execution order in the image forming system 1 having the above-described configuration will be described with reference to FIGS. 6 to 10.

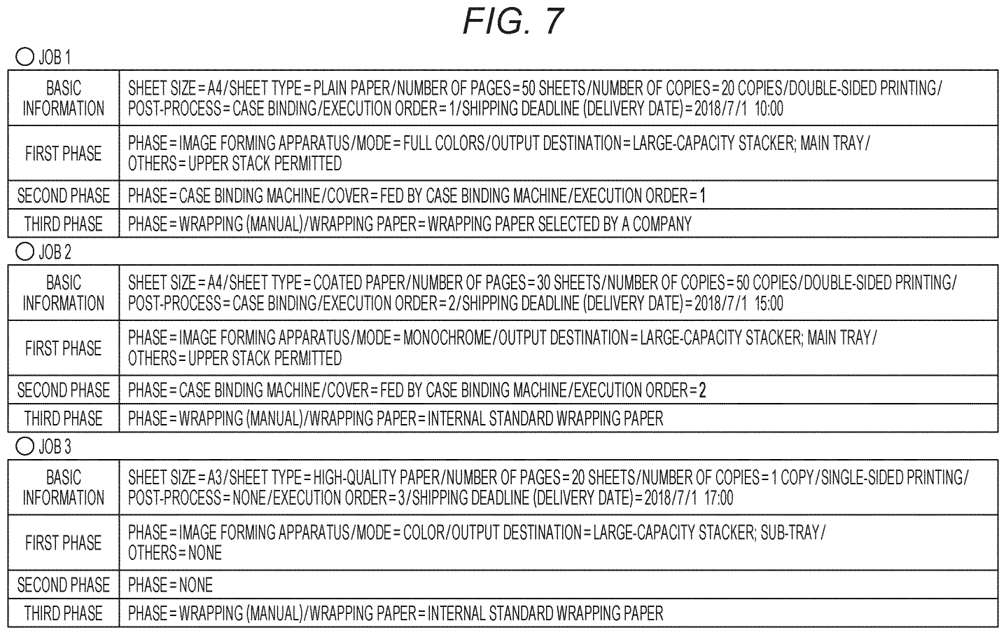

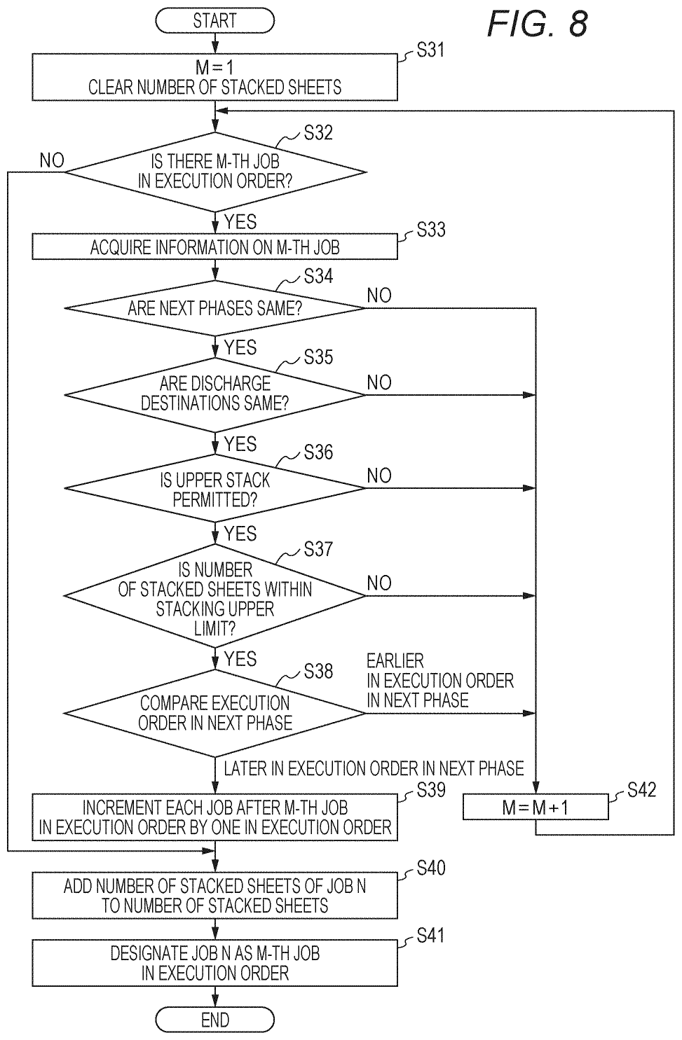

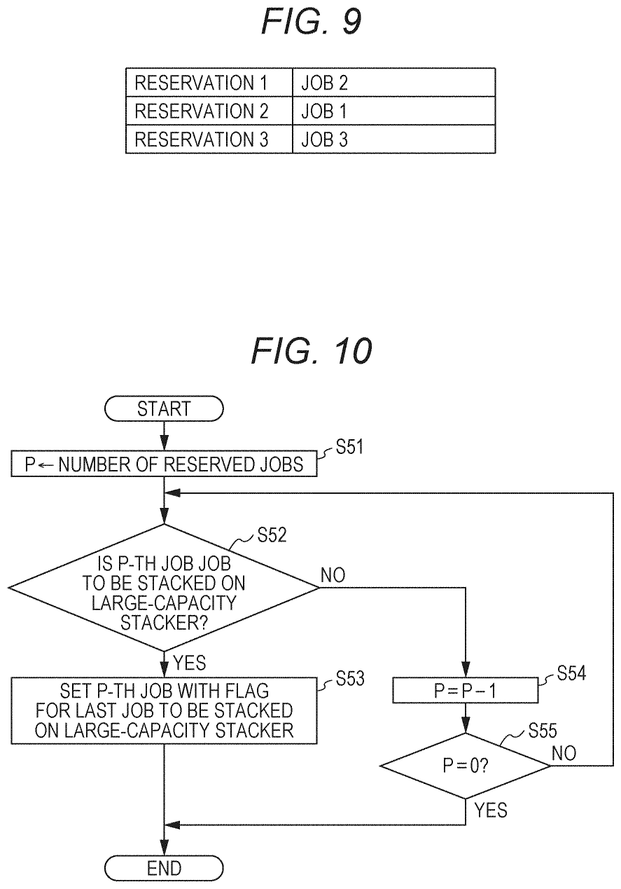

FIG. 6 is a flowchart illustrating the job scheduling process and the job execution process in the image forming apparatus 3. FIG. 7 is an explanatory diagram illustrating an example of the job information. FIG. 8 is a flowchart illustrating an execution order designation process. FIG. 9 is an explanatory diagram illustrating a reservation list designated in the execution order designation process. FIG. 10 is a flowchart illustrating a last job search process.

As illustrated in FIG. 6, the network I/F 305 of the image forming apparatus 3 receives the job information illustrated in FIG. 7 from the network I/F 205 of the information processing apparatus 2 via the network 6 and sets the received job information in the ROM 302, which is a print queue (step S11). Next, the CPU 301 of the image forming apparatus 3 specifies whether to start scheduling (step S12). In the process in step S12, the CPU 301 starts scheduling according to a determination condition such as a case where a predetermined number of jobs is received, a case where the warm-up action of the image forming apparatus 3 is completed, or a case where the total number of the sheets S to be processed reaches the stacking upper limit of the stacker part 43.

Next, in the process in step S12, when it is specified that the CPU 301 is to start scheduling (determined as YES in step S12), the CPU 301 sets a job N with 1 (N=1) (step S13). Then, the CPU 301 designates the execution order for the job N (step S14). Note that the execution order designation process for the job N in step S14 will be described later. Next, the CPU 301 specifies whether or not the execution order of all the received jobs has been designated (step S15).

In the process in step S15, when it is specified that the execution order of all the received jobs has not been designated by the CPU 301 (determined as NO in step S15), the CPU 301 adds 1 to N (N=N+1) (step S16). Then, the CPU 301 returns to the process in step S14 and designates the execution order for the job N.

Meanwhile, when it is specified in the process in step S15 that the execution order of all the received jobs has been designated by the CPU 301 (determined as YES in step S15), the received jobs are displayed in the execution order on the operation display part 33 as reserved jobs (step S17). This display allows the user to know that the job execution order has been modified when the modification has been made.

Next, the CPU 301 searches for a last job to be stacked on the large-capacity stacker 4 (step S18). Note that the last job search process in step S18 will be described later. In addition, the CPU 301 sets a job execution order J with 1 (J=1) (step S19).

Next, the CPU 301 prints a J-th job in the execution order, that is, executes an image forming process (step S20). Furthermore, it is specified whether or not a job on which the CPU 301 has performed the process in step S20 is the last job to be stacked on the large-capacity stacker 4 (step S21). Note that, in the process in step S21, the last job is specified according to the CPU 301 specifying whether or not the current job is a job set with a last job flag in the process in step S18.

In the process in step S21, when the CPU 301 specifies that the current job is the last job to be stacked on the large-capacity stacker 4 (determined as YES in step S21), the CPU 301 displays permission for removal from the large-capacity stacker 4 on the operation display part 33 (step S22). This display allows the user to be notified that the sheet bundle can be removed from the large-capacity stacker 4.

In addition, in the process in step S22, removal permission information is output from the post-stage I/F 306 to the pre-stage I/F 405 of the large-capacity stacker 4. Then, upon receiving the removal permission information, the CPU 401 of the large-capacity stacker 4 operates the lock mechanism 44 to unlock the lock mechanism 44. With this operation, the sheet bundle is allowed to be removed from the large-capacity stacker 4 together with the carriage 42.

Once the process in step S22 is completed, the CPU 301 performs the process in step S23. Meanwhile, in the process in step S21, when the CPU 301 specifies that the current job is not the last job to be stacked on the large-capacity stacker 4 (determined as NO in step S21), the CPU 301 performs the process in step S23 without performing the process in step S22.

In the process in step S23, the CPU 301 specifies whether or not printing of all the jobs is completed. In the process in step S23, when it is specified that printing of all the jobs is not completed (determined as NO in step S23), the CPU 301 adds 1 to the job execution order J (J=J+1) (step S24). Then, the CPU 301 returns to the process in step S20 again.

Meanwhile, in the process in step S23, when the CPU 301 specifies that printing of all the jobs is completed (determined as YES in step S23), the CPU 301 completes the execution process in the image forming apparatus 3.

Note that, in the present example, the process in step S21 is performed before the process in step S23. With this procedure, when a job to be stacked on the large-capacity stacker 4 is completed before printing of all the jobs is completed, the sheet bundle can be removed from the large-capacity stacker 4.

[Execution Order Designation Process]

Next, the execution order designation process according to the process in step S14 mentioned above will be described with reference to FIGS. 7 to 9.

As illustrated in FIG. 8, the CPU 301 of the image forming apparatus 3 sets an execution order M with 1 (M=1), and clears the number of stacked sheets (step S31). Note that the process of clearing the number of stacked sheets is performed only for a first job for which the execution order is to be designated.

Next, the CPU 301 specifies whether or not there is an M-th job in the execution order (step S32). Then, in the process in step S32, when it is specified that there is no M-th job in the execution order (determined as NO in step S32), the CPU 301 performs the process in step S40 described later.

Meanwhile, in the process in step S32, when it is specified that there is the M-th job in the execution order (determined as YES in step S32), the CPU 301 acquires information on the M-th job specified as existing as a job in the execution order (step S33). The information on the job acquired by the CPU 301 in the process in step S33 is, for example, information (JDF) illustrated in FIG. 7.

Next, it is specified whether or not the next phase of a job for which the execution order is to be designated is the same as the next phase of the M-th job (step S34). Note that, in the present example, it is assumed here that the image forming process in the image forming apparatus 3 is the first phase, and the process in the post-processing apparatus (for example, the case binding machine 5) is the second phase. In the process in step S34, when the CPU 301 specifies that the next phases are not the same (determined as NO in step S34), the CPU 301 performs the process in step S42 described later.

Meanwhile, in the process in step S34, when the CPU 301 specifies that the next phases are the same (determined as YES in step S34), it is specified whether or not the discharge destination of the job for which the execution order is to be designated is the same as the discharge destination of the M-th job (step S35). In the comparison of the discharge destinations in the process in step S35, the discharge destinations in the image forming apparatus 3 are compared. In the example illustrated in FIG. 7, the contents of “output destination” in the first phase are compared.

In the process in step S35, when the CPU 301 specifies that the discharge destinations are different (determined as NO in step S35), the CPU 301 performs the process in step S42 described later. Meanwhile, in the process in step S35, when the CPU 301 specifies that the discharge destinations are the same (determined as YES in step S35), the CPU 301 specifies whether or not the upper stack is permitted for the job for which the execution order is to be designated and the M-th job (step S36).

The upper stack permission is permission or prohibition information on discharging and stacking on the upper stack in the stacker part 43 of the large-capacity stacker 4, which is one of the discharge destinations from the image forming apparatus 3. In the example illustrated in FIG. 7, the determination is made according to the contents of “others” in the first phase. Note that, although the example of making determination from the job information illustrated in FIG. 7 has been described, the present invention is not limited to this example; for example, determination may be made according to setting information on the image forming apparatus 3.

In the process in step S36, when the CPU 301 specifies that the upper stack is not permitted (determined as NO in step S36), the CPU 301 performs the process in step S42 described later. Meanwhile, in the process in step S36, when the CPU 301 specifies that the upper stack is permitted (determined as YES in step S36), the CPU 301 specifies whether or not the number of stacked sheets is within the stacking upper limit (step S37).

In the process in step S37, it is specified whether or not the stacking upper limit of a main tray of the large-capacity stacker 4, which is one of the discharge destinations of the image forming apparatus 3, is to be exceeded by executing the job. In order to perform the process in step S37, the CPU 301 adds the number of stacked sheets in the process in step S40 described later. The number of stacked sheets is given as a number obtained by multiplying the number of pages and the number of copies, which are contained in the basic information of the job information illustrated in FIG. 7. In more detail, not only the number of sheets but also information such as the basis weight and thickness of the sheet S may be considered.

In the process in step S37, when the CPU 301 specifies that the stacking upper limit is to be exceeded by executing the job (determined as NO in step S37), the CPU 301 performs the process in step S42 described later. Meanwhile, in the process in step S37, when the CPU 301 specifies that the number of stacked sheets is to remain within the stacking upper limit even after executing the job (determined as YES in step S37), the CPU 301 compares the execution order in the next phase of the job for which the execution order is to be designated, with the execution order in the next phase of the M-th job (step S38).

The execution order compared in the process in step S38 is “execution order” in the second phase (next phase) of the jobs illustrated in FIG. 7. In the process in step S38, when it is specified that “execution order” in the next phase of the job for which the execution order is to be designated is later than “execution order” in the next phase of the M-th job, CPU 301 performs the process in step S39. Meanwhile, in the process in step S38, when it is specified that the execution order in the next phase of the job for which the execution order is to be designated is earlier than the execution order in the next phase of the M-th job, the CPU 301 performs the process in step S42.

In the process in step S39, the CPU 301 increments each job after the M-th job by one in the execution order, including the M-th job already with reservation in the execution order. That is, jobs already with reservation are each modified backward by one in the execution order in the image forming apparatus 3.

Next, once the process in step S39 is terminated or determination as NO is made in the process in step S32, the CPU 301 adds the number of stacked sheets of the job N for which the execution order is to be designated, to the number of stacked sheets (step S40). Note that the process of adding the number of stacked sheets in step S40 is performed for each tray on which sheets are stacked. Next, the CPU 301 designates the job N as M in the execution order (step S41). With this step, the execution order designation process is terminated.

In addition, in the process in step S42, the CPU 301 adds 1 to the execution order M (M=M+1). Then, the CPU 301 returns to the process in step S32 again.

Next, the process of designating the execution order of jobs 1, 2 and 3 of the job information illustrated in FIG. 7 will be described.

Initially, the process of designating the execution order for job 1 will be described. In the process in step S31, the CPU 301 sets the execution order M for job 1 with 1 and clears the number of stacked sheets. Since the M-th job, that is, the first job in the execution order has not been designated yet, the CPU 301 makes determination as NO in the process in step S32.

Next, the CPU 301 adds the number of stacked sheets of job 1 in the process in step S40. As illustrated in FIG. 7, since “number of pages” of job 1 is “50 sheets” and “number of copies” thereof is “20 copies”, a number of stacked sheets of “1000” is added to the main tray of the large-capacity stacker 4, which is the output destination of job 1.

Next, in the process in step S41, the CPU 301 designates job 1 as the M-th job, that is, the first job in the execution order. In the job reservation list at this time point, job 1 is reserved as the first job in the execution order.

Next, the execution order for job 2 is designated. Initially, the CPU 301 sets the execution order M for job 2 with 1 in the process in step S31. Note that, since job 1 is already designated as the first job, which is the M-th job in the execution order, the CPU 301 specifies, in the process in step S32, that a job exists as the M-th job in the execution order (determined as YES in step S32). Next, in the process in step S33, the CPU 301 acquires information on job 1, which is the M-th job.

Next, the CPU 301 performs the processes from step S34 to step S38 to compare information on job 2 for which the execution order is to be designated, with information on M-th job 1. Note that, as illustrated in FIG. 7, since the second phase of job 1 and the second phase of job 2 both have “case binding machine”, the process in step S34 is determined as YES. In addition, since the discharge destinations of job 1 and job 2 are both “large-capacity stacker; main tray”, the process in step S35 is determined as YES. Furthermore, since the contents of “others” in the first phases of job 1 and job 2 have “upper stack permitted”, the process in step S36 is determined as YES.

Additionally, according to the basic information illustrated in FIG. 7, since “number of pages” of job 2 is “30 sheets” and “number of copies” of job 2 is “50 copies”, the number of stacked sheets of job 2 is given as “1500”. Then, if the cumulative number of stacked sheets “2500” obtained by adding “1500”, which is the number of stacked sheets of job 2, to “1000”, which is the number of stacked sheets of job 1, is within the stacking upper limit, the CPU 301 makes determination as YES in the process in step S37. Here, a case where the process in step S37 is determined as YES, that is, a case where the cumulative number of stacked sheets is within the stacking upper limit will be described.

Meanwhile, as illustrated in FIG. 7, “execution order” of job 2 in the second phase is set to “2”, and “execution order” of job 1 in the second phase is set to “1”. Therefore, in the process in step S38, the CPU 301 specifies that “execution order” of job 2 in the second phase is later than “execution order” of job 1, which is the M-th job, in the second phase. Then, in the process in step S39, the CPU 301 increments each job after the M-th (first) job in the execution order, that is, job 1 by one in the execution order. Therefore, job 1 is modified to the second job in the execution order.

Then, in step S40, the CPU 301 adds “1500”, which is the number of stacked sheets of job 2, to the main tray of the large-capacity stacker 4, which is the output destination of job 2 (1000+1500=2500). Next, in the process in step S41, the CPU 301 designates job 2 as the M-th job, that is, the first job in the execution order. In the job reservation list at this time point, job 2 is reserved as the first job in the execution order, and job 1 is reserved as the second job in the execution order.

Next, the execution order for job 3 is designated. Initially, the CPU 301 sets the execution order M for job 3 with 1 in the process in step S31. Note that, since job 2 is already designated as the first job, which is the M-th job in the execution order, the CPU 301 specifies, in the process in step S32, that a job exists as the M-th job in the execution order (determined as YES in step S32). Next, in the process in step S33, the CPU 301 acquires information on job 2, which is the M-th job.

Next, the CPU 301 performs the processes from step S34 to step S38 to compare information on job 3 for which the execution order is to be designated, with information on M-th job 2. As illustrated in FIG. 7, the second phase of job 2 has “case binding machine”, whereas the second phase of job 3 has “none”. Therefore, the process in step S34 is determined as NO, and the CPU 301 performs the process in step S42 to add 1 to the execution order M (M=M+1). That is, the execution order M for job 3 is given as 2. Then, the CPU 301 returns to the process in step S32.

In addition, since job 1 is already designated as the M-th job, that is, the second job in the execution order, the CPU 301 specifies, in the process in step S32, that a job exists as the M-th job in the execution order (determined as YES in step S32). Next, in the process in step S33, the CPU 301 acquires information on job 1, which is the M-th job.

Next, the CPU 301 performs the processes from step S34 to step S38 to compare information on job 3 for which the execution order is to be designated, with information on M-th job 1. As illustrated in FIG. 7, the second phase of job 1 has “case binding machine”, whereas the second phase of job 3 has “none”. Therefore, the process in step S34 is determined as NO, and the CPU 301 performs the process in step S42 to add 1 to the execution order M (M=M+1). That is, the execution order M for job 3 is given as 3. Then, the CPU 301 returns to the process in step S32.

Note that, since the third job in the execution order has not been designated yet, the CPU 301 makes determination as NO in the process in step S32. Next, the CPU 301 adds the number of stacked sheets of job 3 in the process in step S40. As illustrated in FIG. 7, since “number of pages” of job 3 is “20 sheets” and “number of copies” thereof is “1 copy”, a number of stacked sheets of “20” is added to a sub-tray of the large-capacity stacker 4, which is the output destination of job 3.

Next, in the process in step S41, the CPU 301 designates job 3 as the M-th job, that is, the third job in the execution order. Then, in the reservation list, job 2 is reserved as the first job in the execution order, and job 1 is reserved as the second job in the execution order, as illustrated in FIG. 9. Additionally, job 3 is reserved as the third job in the execution order. Consequently, the execution order of jobs 1, 2 and 3 illustrated in FIG. 7 in the image forming apparatus 3 is designated.

As described above, by modifying the execution order in the image forming apparatus 3 based on the execution order in the next phase performed after the image forming apparatus 3, the work for setting sheets in the post-processing apparatus is more easily performed and the burden on the user is reliably reduced.

[Last Job Search Process]

Next, the last job search process according to the process in step S18 mentioned above will be described with reference to FIG. 10.

As illustrated in FIG. 10, the CPU 301 sets the number of reserved jobs to a count P based on the job information input from the information processing apparatus 2 (step S51). Next, the CPU 301 specifies whether or not a P-th job is a job to be stacked on the large-capacity stacker 4 (step S52). In step S52, when the CPU 301 specifies that the P-th job is not a job to be stacked on the large-capacity stacker 4 (determined as NO in step S52), the CPU 301 subtracts 1 from the value of the count P (P=P−1) (step S54). Next, the CPU 301 specifies whether or not P=0 is held (step S55).

In the process in step S55, when the CPU 301 specifies that P=0 is not held (determined as NO in step S55), the CPU 301 returns to the process in step S52.

Meanwhile, in the process in step S52, when it is specified that the P-th job is a job to be stacked on the large-capacity stacker 4 (determined as YES in step S52), the CPU 301 sets the P-th job with a job flag indicating that the P-th job is the last job to be stacked on the large-capacity stacker 4 (step S53). With this step, the job search process is terminated.

In addition, in the process in step S55, when the CPU 301 specifies that P=0 is held (determined as YES in step S55), the job search process is terminated. As described above, in the job search process, it is searched whether or not the job is to be stacked on the large-capacity stacker, in order from the last job among a plurality of jobs.

### 2. Second Embodiment

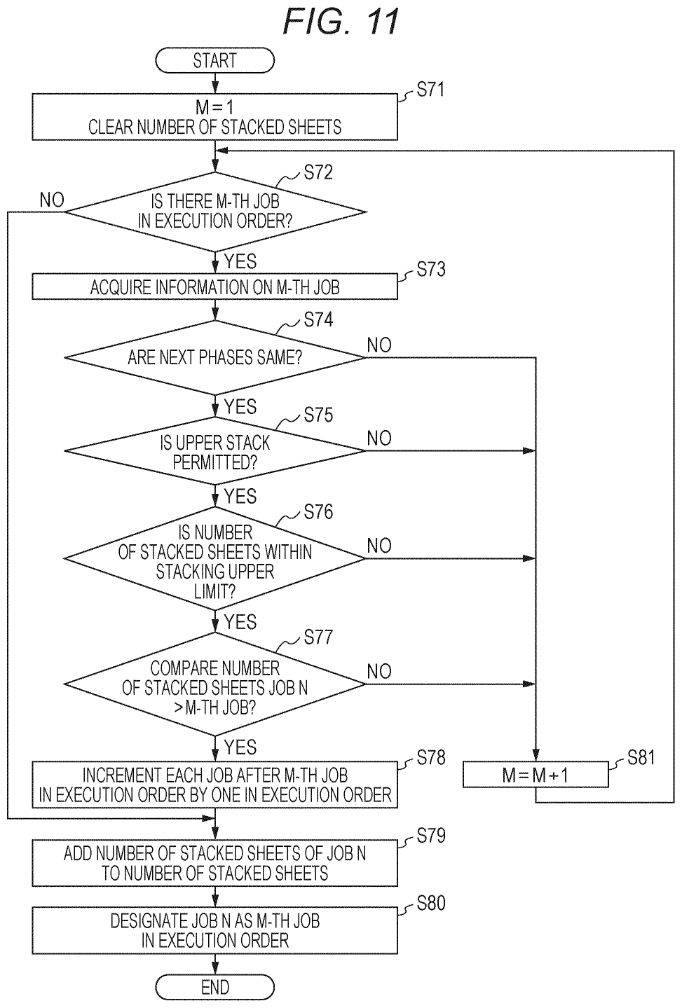

Next, an image forming system according to a second embodiment will be described with reference to FIGS. 11 to 13.

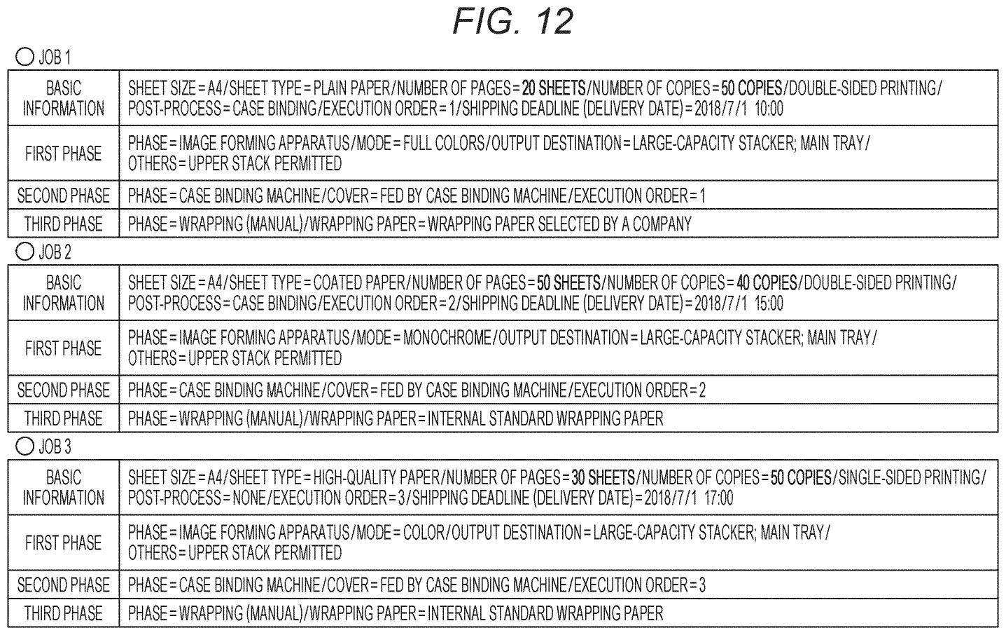

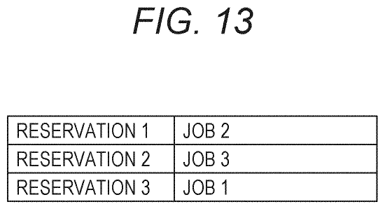

FIG. 11 is a flowchart illustrating an execution order designation process. FIG. 12 is an explanatory diagram illustrating an example of the job information. FIG. 13 is an explanatory diagram illustrating a reservation list designated in the execution order designation process.

This image forming system according to the second embodiment differs from the image forming system 1 according to the first embodiment in the execution order designation process. Therefore, the execution order designation process will be described here; components common to the image forming system 1 according to the first embodiment are denoted by the same reference numerals and the redundant description will be omitted.

As illustrated in FIG. 11, a CPU 301 of an image forming apparatus 3 sets an execution order M with 1 (M=1), and clears the number of stacked sheets (step S71). Note that the process of clearing the number of stacked sheets is performed only for a first job for which the execution order is to be designated.

Next, the CPU 301 specifies whether or not there is an M-th job in the execution order (step S72). Then, in the process in step S72, when it is specified that there is no M-th job in the execution order (determined as NO in step S72), the CPU 301 performs the process in step S79 described later.

Meanwhile, in the process in step S72, when it is specified that there is the M-th job in the execution order (determined as YES in step S72), the CPU 301 acquires information on the M-th job specified as existing as a job in the execution order (step S73). The information on the job acquired by the CPU 301 in the process in step S73 is, for example, information (JDF) illustrated in FIG. 12.

Next, the CPU 301 specifies whether or not the discharge destination of the job for which the execution order is to be designated is the same as the discharge destination of the M-th job (step S74). In the comparison of the discharge destinations in the process in step S74, the discharge destinations in the image forming apparatus 3 are compared.

In the process in step S74, when the CPU 301 specifies that the discharge destinations are different (determined as NO in step S74), the CPU 301 performs the process in step S81 described later. Meanwhile, in the process in step S74, when the CPU 301 specifies that the discharge destinations are the same (determined as YES in step S74), the CPU 301 specifies whether or not the upper stack is permitted for the job for which the execution order is to be designated and the M-th job (step S75).

In the process in step S75, when the CPU 301 specifies that the upper stack is not permitted (determined as NO in step S75), the CPU 301 performs the process in step S81 described later. Meanwhile, in the process in step S75, when the CPU 301 specifies that the upper stack is permitted (determined as YES in step S75), the CPU 301 specifies whether or not the number of stacked sheets is within the stacking upper limit (step S76).

In the process in step S76, when the CPU 301 specifies that the stacking upper limit is to be exceeded by executing the job (determined as NO in step S76), the CPU 301 performs the process in step S81 described later. Meanwhile, in the process in step S76, when the CPU 301 specifies that the number of stacked sheets is to remain within the stacking upper limit even after executing the job (determined as YES in step S76), the CPU 301 compares the number of stacked sheets of a job N for which the execution order is to be designated, with the number of stacked sheets of the M-th job (step S77). In the process in step S77, it is specified whether or not the number of stacked sheets of the job N for which the execution order is to be designated is greater than the number of stacked sheets of the M-th job (the number of sheets×the number of copies of job N>the number of sheets×the number of copies of the M-th job).

In the process in step S77, when the CPU 301 specifies that the number of stacked sheets of the job N for which the execution order is to be designated is smaller than the number of stacked sheets of the M-th job (determined as NO in step S77), the CPU 301 performs the process in step S81. Meanwhile, in the process in step S77, when it is specified that the number of stacked sheets of the job N for which the execution order is to be designated is greater than the number of stacked sheets of the M-th job (determined as YES in step S77), the CPU 301 performs the process in step S78.

In the process in step S78, the CPU 301 increments each job after the M-th job by one in the execution order, including the M-th job already with reservation in the execution order. That is, jobs already with reservation are each modified backward by one in the execution order in the image forming apparatus 3.

Next, once the process in step S78 is terminated or determination as NO is made in the process in step S72, the CPU 301 adds the number of stacked sheets of the job N for which the execution order is to be designated, to the number of stacked sheets (step S79). Next, the CPU 301 designates the job N as M in the execution order (step S80). With this step, the execution order designation process is terminated.

In addition, in the process in step S81, the CPU 301 adds 1 to the execution order M (M=M+1). Then, the CPU 301 returns to the process in step S72 again.

Next, the process of designating the execution order of jobs 1, 2 and 3 of the job information illustrated in FIG. 12 will be described.

Initially, the process of designating the execution order for job 1 will be described. In the process in step S71, the CPU 301 sets the execution order M for job 1 with 1 and clears the number of stacked sheets. Since the M-th job, that is, the first job in the execution order has not been designated yet, the CPU 301 makes determination as NO in the process in step S72.

Next, the CPU 301 adds the number of stacked sheets of job 1 in the process in step S79. As illustrated in FIG. 12, since “number of pages” of job 1 is “20 sheets” and “number of copies” thereof is “50 copies”, a number of stacked sheets of “1000” is added to the main tray of a large-capacity stacker 4, which is the output destination of job 1.

Next, in the process in step S80, the CPU 301 designates job 1 as the M-th job, that is, the first job in the execution order. In the job reservation list at this time point, job 1 is reserved as the first job in the execution order.

Next, the execution order for job 2 is designated. Initially, the CPU 301 sets the execution order M for job 2 with 1 in the process in step S71. Note that, since job 1 is already designated as the first job, which is the M-th job in the execution order, the CPU 301 specifies, in the process in step S72, that a job exists as the M-th job in the execution order (determined as YES in step S72). Next, in the process in step S73, the CPU 301 acquires information on job 1, which is the M-th job.

Next, the CPU 301 performs the processes from step S74 to step S77 to compare information on job 2 for which the execution order is to be designated, with information on M-th job 1. Since the discharge destinations of job 1 and job 2 are both “large-capacity stacker; main tray”, the process in step S74 is determined as YES. Furthermore, since the contents of “others” in the first phases of job 1 and job 2 have “upper stack permitted”, the process in step S75 is determined as YES.

Additionally, according to the basic information illustrated in FIG. 12, since “number of pages” of job 2 is “50 sheets” and “number of copies” of job 2 is “40 copies”, the number of stacked sheets of job 2 is given as “2000”. Then, if the cumulative number of stacked sheets “3000” obtained by adding “1000”, which is the number of stacked sheets of job 1, to “2000”, which is the number of stacked sheets of job 2, is within the stacking upper limit, the CPU 301 makes determination as YES in the process in step S76. Here, a case where the process in step S76 is determined as YES, that is, a case where the cumulative number of stacked sheets is within the stacking upper limit will be described.

In addition, since the number of stacked sheets of job 2 is “2000” and the number of stacked sheets of job 1 is “1000”, the CPU 301 specifies, in the process in step S77, that the number of stacked sheets of job 2 is greater than the number of stacked sheets of job 1, which is the M-th job (determined as YES in step S77). Then, in the process in step S78, the CPU 301 increments each job after the M-th (first) job in the execution order, that is, job 1 by one in the execution order. Therefore, job 1 is modified to the second job in the execution order.

Then, in step S79, the CPU 301 adds “2000”, which is the number of stacked sheets of job 2, to the main tray of the large-capacity stacker 4, which is the output destination of job 2 (1000+2000=3000). Next, in the process in step S80, the CPU 301 designates job 2 as the M-th job, that is, the first job in the execution order. In the job reservation list at this time point, job 2 is reserved as the first job in the execution order, and job 1 is reserved as the second job in the execution order.

Next, the execution order for job 3 is designated. Initially, the CPU 301 sets the execution order M for job 3 with 1 in the process in step S71. Note that, since job 2 is already designated as the first job, which is the M-th job in the execution order, the CPU 301 specifies, in the process in step S72, that a job exists as the M-th job in the execution order (determined as YES in step S72). Next, in the process in step S73, the CPU 301 acquires information on job 2, which is the M-th job.

Next, the CPU 301 performs the processes from step S74 to step S77 to compare information on job 3 for which the execution order is to be designated, with information on M-th job 2. Since the discharge destinations of job 2 and job 3 are both “large-capacity stacker; main tray”, the process in step S74 is determined as YES. Furthermore, since the contents of “others” in the first phases of job 2 and job 3 have “upper stack permitted”, the process in step S75 is determined as YES.

Additionally, according to the basic information illustrated in FIG. 12, since “number of pages” of job 3 is “30 sheets” and “number of copies” of job 3 is “50 copies”, the number of stacked sheets of job 3 is given as “1500”. Then, if the cumulative number of stacked sheets “4500” obtained by adding “3000”, which is the cumulative number of stacked sheets, to “1500”, which is the number of stacked sheets of job 3, is within the stacking upper limit, the CPU 301 makes determination as YES in the process in step S76. Here, a case where the process in step S76 is determined as YES, that is, a case where the cumulative number of stacked sheets is within the stacking upper limit will be described.

In addition, since the number of stacked sheets of job 3 is “1500” and the number of stacked sheets of job 2 is “2000”, the CPU 301 specifies, in the process in step S77, that the number of stacked sheets of job 3 is smaller than the number of stacked sheets of job 2, which is the M-th job (determined as NO in step S77). Next, the CPU 301 performs the process in step S81 to add 1 to the execution order M (M=M+1). That is, the execution order M for job 3 is given as 2. Then, the CPU 301 returns to the process in step S72.

Furthermore, since job 1 is already designated as the M-th job, that is, the second job in the execution order, the CPU 301 specifies, in the process in step S72, that a job exists as the M-th job in the execution order (determined as YES in step S72). Next, in the process in step S73, the CPU 301 acquires information on job 1, which is the M-th job.

Next, the CPU 301 performs the processes from step S74 to step S77 to compare information on job 3 for which the execution order is to be designated, with information on M-th job 1. Since the discharge destinations of job 1 and job 3 are both “large-capacity stacker; main tray”, the process in step S74 is determined as YES. Furthermore, since the contents of “others” in the first phases of job 1 and job 3 have “upper stack permitted”, the process in step S75 is determined as YES.

In addition, the determination process with respect to the stacking upper limit in step S76 is determined as YES, as described above.

Furthermore, since the number of stacked sheets of job 3 is “1500” and the number of stacked sheets of job 1 is “1000”, the CPU 301 specifies, in the process in step S77, that the number of stacked sheets of job 3 is greater than the number of stacked sheets of job 1, which is the M-th job (determined as YES in step S77). Then, in the process in step S78, the CPU 301 increments each job after the M-th (second) job in the execution order, that is, job 1 by one in the execution order. Therefore, job 1 is modified to the third job in the execution order.

Then, in step S79, the CPU 301 adds “1500”, which is the number of stacked sheets of job 3, to the main tray of the large-capacity stacker 4, which is the output destination of job 3 (3000+1500=4500). Next, in the process in step S80, the CPU 301 designates job 3 as the M-th job, that is, the second job in the execution order.

Then, in the reservation list, job 2 is reserved as the first job in the execution order, and job 3 is reserved as the second job in the execution order, as illustrated in FIG. 13. Additionally, job 1 is reserved as the third job in the execution order. Consequently, the process of designating the execution order of jobs 1, 2 and 3 illustrated in FIG. 12 in the image forming apparatus 3 is terminated.

In the execution order designation process of the image forming system according to the second embodiment, the execution order in the image forming apparatus 3 is designated according to the number of stacked sheets (the number of processed sheets) of each job. Specifically, by performing a job with a smaller number of stacked sheets later, a job with a greater number of stacked sheets is stacked on the lower side in the stacker part 43 of the large-capacity stacker 4, and a job with a smaller number of stacked sheets is stacked on the upper side. With this configuration, also when the order of the sheet bundles of respective jobs is modified in line with the execution order in the post-processing apparatus, the sheet bundle of a job with a smaller number of stacked sheets, that is, a sheet bundle of a job lighter than sheet bundles of other jobs is stacked on the upper side; accordingly, the sheet bundles are more easily removed or moved. As a result, the work for setting sheet in the post-processing apparatus is more easily performed and the burden on the user is reliably reduced.

The embodiments of the image forming system and the image forming server have been described so far, including the effects and advantages thereof. However, the image forming system and the image forming server of the present invention are not limited to the above-described embodiments, and a variety of modifications can be carried out without departing from the scope of the invention described in the claims.

The embodiments described above has assumed a configuration in which a color image is formed using four sets of image forming units; however, the image forming apparatus according to the present invention may have a configuration in which a single image forming unit is used to form a monochrome image.

Furthermore, an example has been described in which the CPU 301 of the image forming apparatus 3 is applied as a controller that designates the execution order, and the CPU 301 of the image forming apparatus 3 performs the execution order designation process and the job search process; however, the present invention is not limited to this example. For example, the CPU 201 of the information processing apparatus 2 may be applied as the controller such that the CPU 201 of the information processing apparatus 2 performs the execution order designation process for the image forming apparatus 3 based on the input job information. Then, the execution order in the image forming apparatus 3 designated by the information processing apparatus 2 may be output to the image forming apparatus 3 along with the image data and the job information. In this case, the network I/F 205 and the input operation part 22 of the information processing apparatus 2 serve as a job information acquirer.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming system comprising:
a job information acquirer that acquires job information made up of a plurality of jobs, the job information indicating contents of a process to be performed on a sheet;
an image former that forms an image on a sheet based on the job information; and
a hardware processor that designates an execution order of the plurality of jobs in the image former, based on a next phase to be performed when the sheets are conveyed from the image former after an image forming phase by the image former for each of the plurality of jobs in the job information.

2. The image forming system according to claim 1, wherein
based on the execution order in the next phase, the hardware processor designates an execution order in the image former of jobs among the plurality of jobs, the jobs to be placed in upper stacks on the same stacking part and having the same contents of a phase in the next phase according to the job information.

3. The image forming system according to claim 2, wherein
the plurality of jobs includes at least a first job and a second job to be performed later than the first job in the next phase, and
the hardware processor
designates an execution order in the image former for the first job such that the first job is executed later than the second job.

4. An image forming system comprising:
a job information acquirer that acquires job information made up of a plurality of jobs, the job information indicating contents of a process to be performed on a sheet;
an image former that forms an image on a sheet based on the job information; and
a hardware processor that designates an execution order of the plurality of jobs in the image former, based on the number of the sheets to be processed for each of the plurality of jobs in the job information.

5. The image forming system according to claim 4, wherein
the hardware processor
designates an execution order in the image former of jobs among the plurality of jobs, the jobs to be placed in upper stacks on the same stacking part according to the job information, such that a job with a greater number of the sheets to be processed is executed earlier.

6. The image forming system according to claim 1, further comprising:
a display part that displays an execution order designated by the hardware processor.

7. The image forming system according to claim 1, further comprising:
an image forming apparatus including the image former;
a sheet stacking apparatus that stacks a sheet on which an image has been formed by the image forming apparatus; and
an information processing apparatus that outputs the job information to the image forming apparatus, wherein
the hardware processor is provided in the image forming apparatus or the information processing apparatus.

8. The image forming system according to claim 7, further comprising:
a post-processing apparatus that performs a post-process on the sheet in the next phase, wherein
the information processing apparatus outputs the job information to the image forming apparatus and the post-processing apparatus.

9. The image forming system according to claim 7, wherein
the hardware processor notifies that the sheets are allowed to be removed from the sheet stacking apparatus, when an image forming process in the image former for a last job stacked on the sheet stacking apparatus among the plurality of jobs is completed.

10. The image forming system according to claim 9, wherein
the sheet stacking apparatus includes a lock mechanism that locks a stacking part on which the sheet is stacked, and unlocks the lock mechanism when the hardware processor notifies that the sheet is allowed to be removed from the sheet stacking apparatus.

11. A non-transitory recording medium storing a computer readable program causing a computer to execute:
causing a job information acquirer to acquire job information made up of a plurality of jobs, the job information indicating contents of a process to be performed on a sheet;
causing an image former to form an image on the sheet based on the job information; and
causing a hardware processor to designate an execution order of the plurality of jobs in the image former, based on a next phase to be performed when the sheets are conveyed from the image former after an image forming phase by the image former for each of the plurality of jobs in the job information.

12. A non-transitory recording medium storing a computer readable program causing a computer to execute:
causing a job information acquirer to acquire job information made up of a plurality of jobs, the job information indicating contents of a process to be performed on a sheet;
causing an image former to form an image on the sheet based on the job information; and
causing a hardware processor to designate an execution order of the plurality of jobs in the image former, based on the number of the sheets to be processed for each of the plurality of jobs in the job information.

13. The image forming system according to claim 4, further comprising:
a display part that displays an execution order designated by the hardware processor.

14. The image forming system according to claim 4, further comprising:
an image forming apparatus including the image former;
a sheet stacking apparatus that stacks a sheet on which an image has been formed by the image forming apparatus; and
an information processing apparatus that outputs the job information to the image forming apparatus, wherein
the hardware processor is provided in the image forming apparatus or the information processing apparatus.
